(19) United States
(12) Patent Application Publication
(10) Pub. No.: US 2005/0210484 A1
(43) Pub. Date: Sep. 22, 2005

(54) Method for adjusting temperature in optical information reproducing apparatus

(75) Inventor: Chih-Tai Cheng, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/073,343

(22) Filed: Mar. 4, 2005

(30) Foreign Application Priority Data
Mar. 17, 2004 (TW) 093107181

(51) Int. Cl. G11B 5/09

(52) U.S. Cl. 720/649

(57) ABSTRACT

The invention discloses a method for adjusting the temperature in an optical information reproducing apparatus, including a spindle motor for driving an optical information medium disposed within the optical information reproducing apparatus and a pick-up head unit for retrieving/recording data from/to the optical information recording medium. By the method according to the invention, the temperature in the optical information reproducing apparatus is cooled down by an air flow caused by the rotating optical information recording medium driven by the spindle motor.

### BACKGROUND OF THE INVENTION

1. Field of the Invention

The invention relates to a method for adjusting the temperature in an optical information reproducing apparatus.

2. Description of the Prior Art

The optical information reproducing apparatus is a player for displaying various kinds of compact discs (CDs), e.g. MO-disc, CD-R, CD-ROM, CD-RAM, CD-RW, DVD-R, DVD-RW, DVD+R, DVD+RW, DVD-ROM, DVD-RAM, Blue Ray Disk (BD), Advance Video Disk (AOD), HD-DVD, and so on.

Generally, during the operation procedure of the optical information reproducing apparatus, most of the elements, especially the pick-up head unit, will generate heat. Therefore, many prior arts have proposed solutions for measuring and cooling down the temperature in the optical information reproducing apparatus.

Relative prior arts about how to measure and cool down the temperature in the optical information reproducing apparatus are listed as follows: U.S. Pat. No. 6,657,932, U.S. Pat. No. 6,067,203, U.S. Pat. No. 5,764,430, and U.S. Pat. No. 5,566,077. The relative prior arts will not be described in detail in this specification.

Although the above prior arts have their objectives respectively, the optical information reproducing apparatus, like the ones in computers, notebooks, or home appliances, still have the chance to be overheated while being used, resulting in shutting down of the apparatus. In other words, the optical information reproducing apparatus of the prior art will still be shut down by overheat, so that the optical information reproducing procedure will be broken off.

Therefore, the objective of the invention is to provide a method for adjusting the temperature in an optical information reproducing apparatus and to enable the optical information reproducing apparatus to maintain operation instead of being shut-down by overheat.

Moreover, the general optical information reproducing apparatus includes a buffer for buffering data retrieved by the pick-up head unit from an optical information recording medium. The data, which an inner processor or an outer processor (e.g. a processor in a host) needs, is then retrieved from the buffer. If the data recorded on the optical information recording medium is desired to be displayed (reproduced) continually, the data buffered in the buffer cannot be under-run.

Therefore, the other objective of the invention is to provide a method for adjusting the temperature in an optical information reproducing apparatus. Furthermore, the buffer in the optical information reproducing system will not be under-run while adjusting the temperature, so as to maintain the procedure for reproducing the optical information.

### SUMMARY OF THE INVENTION

The present invention discloses a method for adjusting the temperature in an optical information reproducing apparatus. The optical information reproducing apparatus includes a spindle motor and a pick-up head unit. The spindle motor is used for driving an optical information medium, disposed within the optical information reproducing apparatus, into rotation. The pick-up head unit is used for retrieving/recording data from/to the optical information recording medium. According to one preferred embodiment of the invention, the speed of the spindle motor is first set at the current speed by a predetermined mode. Then, the temperature in the optical information reproducing apparatus is being measured to see if it reaches a first threshold. If yes in the above step, the predetermined mode for setting the speed of the spindle motor is being disabled, and the speed of the spindle motor is set at a predetermined speed. The pick-up head unit is then inactivated for a first predetermined period. Accordingly, the temperature in the optical information reproducing apparatus is cooled down by an air flow caused by the rotating optical information recording medium driven by the spindle motor.

The advantage and spirit of the invention may be understood by the following recitations together with the appended drawings.

### BRIEF DESCRIPTION OF THE APPENDED DRAWINGS

FIG. 1 is a flowchart of a preferred embodiment according to the invention.

### DETAILED DESCRIPTION OF THE INVENTION

The invention discloses a method for adjusting the temperature in an optical information reproducing apparatus. The invention can be performed on a typical optical reproducing apparatus. In other words, the optical information reproducing apparatus includes a spindle motor, a pick-up head unit, and a buffer. The spindle motor is used for driving an optical information medium, disposed within the optical information reproducing apparatus, into rotation. The pick-up head unit is used for retrieving/recording data from/to the optical information recording medium. The buffer is used for buffering data retrieved by the pick-up head unit from an optical information recording medium. During the procedure for reproducing the optical information, the data, which an inner processor or an outer processor needs, is retrieved from the buffer, wherein the inner processor or the outer processor is used for processing the data retrieved by the pick-up head unit.

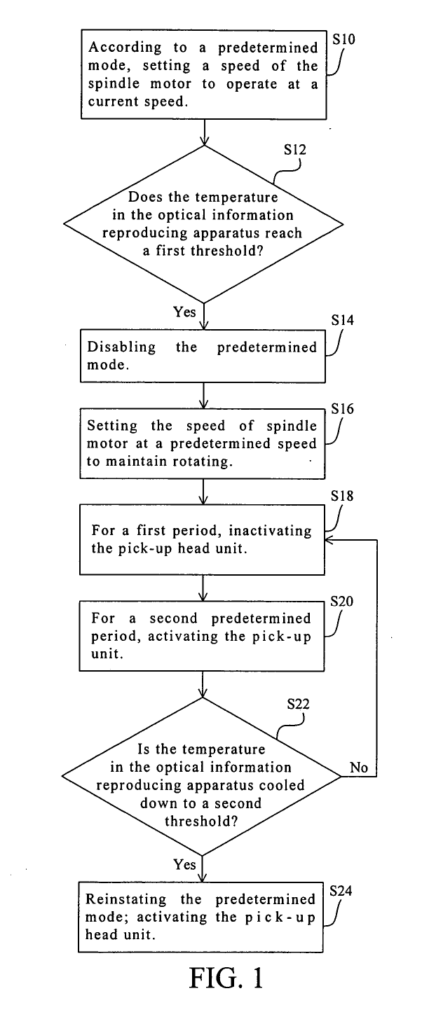

Please refer to FIG. 1. FIG. 1 is a flowchart of the method according to a preferred embodiment of the invention. The method includes the following steps. Perform step S10 first. Set the speed of the spindle motor at a current speed according to a predetermined mode (e.g. constant linear velocity (CLV) mode or constant angular velocity (CAV) mode).

Then, perform step S12. Sense whether the temperature in the optical information reproducing apparatus reaches a first threshold. The location for sensing the temperature, i.e. the location for installing the thermal sensor, is dependent on the practical use of the optical information reproducing apparatus. In general, the thermal sensor is better used for sensing the temperature near the pick-up head unit.

If YES in step S12, perform step S14. Disable the predetermined mode for setting the speed of the spindle motor. Perform step S16 after step S14. Set the speed of the spindle motor at a predetermined speed. Perform step S18 after step S16. Inactivate the pick-up head unit for a first predetermined period.

During step S18, the heat source of the optical information reproducing apparatus disappears. In other words, the relative devices will stop as the pick-up head unit stops running. Consequently, the temperature of the optical information reproducing apparatus will not be raised by the heat generated during the operation of the pick-up head unit.

Accordingly, the temperature in the optical information reproducing apparatus is cooled down by an air flow caused by the rotating optical information recording medium driven by the spindle motor. The technique about the air flow caused by the rotating optical information recording medium is described in Japan Pat. No. 10-092166 and Japan Pat. No. 62-052785. The relative prior arts will not be described in detail in this specification.

When adjusting the temperature in the optical information reproducing apparatus, in a preferred embodiment, step S20 is performed after step S18, so that the buffer will not be under-run. During a second predetermined period, the pick-up head unit is activated. During step S20, the pick-up head unit retrieves/records data from/to the optical information recording medium continually and stores the retrieved/recorded data into the buffer. In this way, the buffer will not be under-run.

In a preferred embodiment, step S22 is performed after step S20. The temperature in the optical information reproducing apparatus is being measured to see if it has cooled down to a second threshold. If it is a NO in step S22, step S18 to step S22 are being repeated. If it is a YES in step S22, step S24 is performed. The predetermined mode which determines the speed of the spindle motor is reinstated, and the pick-up head unit is activated.

A 12X DVD burner is taken as an example in the following for further describing all of the above-mentioned conditions.

Once the temperature in the 12X DVD burner reaches 80° C., the 12X DVD burner may be shut down or the inner parts may be damaged by overheat. According to the method of the present invention, the first threshold in the above is set as 75° C., the second threshold in the above is set as 72° C., the first predetermined period in the above is set as 1 second, and the second predetermined period in the above is set as 1 second.

First, the speed of the spindle motor is set at the current speed according to the CAV mode. In general, the speed of the spindle motor reaches 7200 rpm for 12X.

Then, the temperature in the 12X DVD burner is measured to see whether it reaches 75° C. If the temperature in the 12X DVD burner reaches 75° C., the CAV mode for setting the speed of the spindle motor is disabled. The speed of the spindle motor is set at a lower predetermined speed, e.g. 3600 rpm. The pick-up head of the 12X DVD burner is then inactivated for 1 second (the first predetermined period is set as 1 second). Consequently, the temperature of the 12X DVD burner will not be raised by the heat generated by the operation of the pick-up head. Also, the temperature in the 12X DVD burner is cooled down by an air flow caused by the rotating compact disc driven by the spindle motor.

After the pick-up head is inactivated for 1 second, the pick-up head is then activated for 1 second (the second predetermined period is set as 1 second), so that the buffer in the 12X DVD burner will not be under-run.

Then, the pick-up head is inactivated for 1 second and activated again for 1 second repeatedly until the temperature in the 12X DVD burner is cooled down to 72° C. When the temperature in the 12X DVD burner is cooled down to 72° C., the CAV mode which determines the speed of the spindle motor is reinstated, and the pick-up head is activated.

Obviously, according to the method of the invention, the optical information reproducing apparatus can still maintain operation instead of being shut-down by overheat and can reproduce the data recorded on the optical information recording medium.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method for adjusting the temperature in an optical information reproducing apparatus comprising a spindle motor for driving an optical information medium, disposed within the optical information reproducing apparatus, into rotation and a pick-up head unit for retrieving/recording data from/to the optical information recording medium, said method comprising the steps of:
(a) sensing whether the temperature in the optical information reproducing apparatus reaches a first threshold;
(b) if YES in step (a), performing the steps of:
(b1) maintaining the rotating of spindle motor; and
(b2) inactivating the pick-up head unit; whereby the temperature in the optical information reproducing apparatus is cooled down by an air flow caused by the rotating optical information recording medium driven by the spindle motor.

2. The method of claim 1, wherein in step (b2), the pick-up head unit is inactivated for a first predetermined period.

3. The method of claim 2, further comprising the step of
(b3) activating the pick-up head unit for a second predetermined period.

4. The method of claim 3, wherein the speed of the spindle motor is normally set according to a predetermined mode, in step (b1), the predetermined mode, to which the speed of the spindle motor is set accordingly, is disabled, the speed of the spindle motor is set at a predetermined speed to maintain rotation.

5. The method of claim 4, further comprising the steps of:
(b4) repeating step (b2) and step (b3) until the temperature in the optical information reproducing apparatus is cooled down to a second threshold; and
(b5) reinstating the predetermined mode which the speed of the spindle motor is set according to, and activating the pick-up head unit.
